(19) United States
(12) Patent Application Publication
(10) Pub. No.: US 2026/0309882 A1
(43) Pub. Date: Oct. 8, 2026

(54) A METHOD OF AND A DEVICE FOR PROCESSING RECORDED SEISMIC DATA

(71) Applicant: FNV IP B.V., Nootdorp (NL)

(72) Inventors: Chad Allen PASTOR, Crowley, LA (US); Sanket BHATTACHARYA, Nootdorp (NL); Talfryn Theo GRIFFITHS, Nootdorp (NL)

(21) Appl. No.: 19/483,877

(22) PCT Filed: May 22, 2024
(86) PCT No.: PCT/EP2024/064080

§ 371 Date: Nov. 12, 2025

(30) Foreign Application Priority Data
May 30, 2023 (NL) 2034949

(51) Int. Cl. G01V 1/28; G01V 1/36

(52) U.S. Cl. CPC G01V 1/282; G01V 1/368; G01V 2210/127; G01V 2210/1293

(57) ABSTRACT

A method of processing recorded seismic data is disclosed. The recorded seismic data os obtained in response to an acoustic signal transmitted using a transducer of a parametric sub-bottom profiling system, a wave shape of the transmitted acoustic signal varies as a function of water depth. The method is performed by a processor and comprises the steps of: determining a plurality of source signatures of the transmitted acoustic signal respectively for a plurality of adjacent water depth ranges, where each water depth range being smaller than a range threshold; deriving a unit-impulse response for each one of the water depth ranges by deconvolving the source signature of the seismic signal at that water depth range; generating a model representing relationship between the source signature of the transmitted acoustic signal at each water depth range and that water depth range based on the derived unit-impulse response for all the water depth ranges; and processing the recorded seismic data by applying the model to the recording seismic data. Unlocking insights from Geo-Data, the present invention further relates to improvements in sustainability and environmental developments: together we create a safe and liveable world.

### FIELD OF THE INVENTION

The present disclosure generally relates to the field of seismic data processing, and more specifically to a method of and a device for processing recorded seismic data obtained in response to an acoustic signal transmitted using a transducer of a parametric sub-bottom profiling system and having a wave shape varying as a function of water depth. Unlocking insights from Geo-Data, the present invention further relates to improvements in sustainability and environmental developments: together we create a safe and liveable world.

### BACKGROUND OF THE INVENTION

Geophysical surveying or other marine search operations often require vessel hull mounted acoustic parametric sub-bottom profiler for the purpose of creating a subsurface image beneath the seafloor. The subsurface images, also known as image profiles, are used to classify, and identify geohazard targets for various types such as river channels, faults, boulders, or other geo hazards.

The parametric sub-bottom profilers make use of a technique called parametric sub-bottom profiling, which involves mixing two high-frequency signals to generate a lower-frequency signal for penetration. This technique allows for increased depth penetration while maintaining a manageable source size.

In particular, in parametric sub-bottom profilers, two high-frequency signals, typically in the ultrasonic range, are generated by a same or separate transducers. These high-frequency signals are mixed in the water, resulting in the generation of a secondary signal with a lower frequency through a non-linear interaction known as parametric arraying.

The lower-frequency signal created through this mixing process can effectively penetrate the sediment layers with reduced attenuation compared to the original high-frequency signals. As a result, the parametric sub-bottom profiler can achieve greater depth penetration and provide detailed imaging of the sub-bottom structure, in part to a very narrow seismic beam.

In the parametric sub-bottom profiling, as in other marine seismic exploration applications, sources commonly used are impulsive sources. The lower-frequency signal generated by an impulsive source through the mixing of two high-frequency signals is an acoustic wave or signal with a relatively narrow frequency band. This source acoustic signal manifests itself as a relatively long source wavelet in the time domain. For the purpose of improving image resolution of subsurface images obtained from parametric sub-bottom profiling and extracting the most penetration, a designature process is usually applied on parametric raw data to compress the wavelet and broaden the frequency bandwidth.

With an impulsive seismic source, the seismic wavelet is concentrated within a narrow frequency band, and any frequency-dependent attenuation effects in the subsurface will affect the recorded data more prominently, which would impact subsequent analysis and interpretation steps. An impulsive seismic source may be generated with for example an air gun.

The secondary lower-frequency signal, when propagating or travelling in the water, is subject to propagation effects. As a result, a wave shape or waveform of the secondary lower-frequency signal used in the parametric sub-bottom profiler system changes as a function of a distance from the transducer. In other words, the wave shape or waveform of the source signal is water depth dependent.

The variation of the waveform of the source signal used in the parametric sub-bottom profiler systems may have certain disadvantageous effects. As an example, varying waveforms can result in inconsistent data quality across different depths. This can make it challenging to compare and correlate seismic data obtained at different depths, hampering the accuracy and reliability of subsurface imaging. Moreover, varying waveforms can introduce additional complexity to the interpretation process.

In consideration of the above, it is desirable that a method of processing recorded seismic data which allows improved data resolution is available.

### BRIEF SUMMARY OF THE INVENTION

According to one aspect of the present disclosure, there is presented a method of processing recorded seismic data, the recorded seismic data obtained in response to an acoustic signal transmitted using a transducer of a parametric sub-bottom profiling system, a wave shape of the transmitted acoustic signal varying as a function of water depth, the method performed by a processor and comprising the steps of:
determining a plurality of source signatures of the transmitted acoustic signal respectively for a plurality of water depth ranges, where each water depth range is smaller than a range threshold;
deriving a unit-impulse response for each one of the water depth ranges by deconvolving the source signature of the seismic signal at that water depth range;
generating a model representing a relationship between the source signature of the transmitted acoustic signal at each water depth range and that water depth range based on the derived unit-impulse response for all the water depth ranges; and
processing the recorded seismic data by applying the model to the recording seismic data.

The present disclosure is based on the insight that impact caused by varying of the wave shape, dependent on the water depth, of the transmitted acoustic signal of the parametric sub-bottom profiling system on recorded seismic data may be eliminated or at least reduced or mitigated by way of a model derived by taking into consideration of unit-impulse responses of a plurality of water depth ranges.

For the purpose of generating or obtaining such a model, source signatures of the transmitted acoustic signal are decided or determined at the plurality of water depth ranges. From these source signatures, the unit-impulse response at each one of the water depth ranges is obtained by applying a deconvolution process to the source signature at that water depth ranges.

Deconvolution is known to those skilled in the art and a computational method that treats the image as an estimate of the true specimen intensity and using an expression for the point spread function performs the mathematical inverse of the imaging process to obtain an improved estimate of the image intensity.

The thus derived unit-impulse responses at the plurality of water depth ranges are assembled to create or generate a model. This model represents relationship between the source signature of the transmitted acoustic signal at each water depth range and that water depth range. Such a model is then applied to the seismic data recorded using the parametric sub-bottom profiling system, which helps to improve data or image resolution of subsurface images obtained from the recorded seismic data.

In an example of the present disclosure, the transmitted acoustic signal comprises a first frequency and a second frequency, the first frequency and second frequency interact to produce a third frequency equal to a difference between the first frequency and the second frequency, the recorded seismic data is of the third frequency.

The method of the present disclosure is especially advantageous for parametric sub-bottom profiling systems using parametric arraying, in which a source acoustic signal with a lower frequency, herein the third frequency, is obtained by mixing two signals of higher frequencies, herein the first and second frequencies. The wave shape or waveform of such a source signal, due to propagation effects such as attenuation, reflection, and refraction, vary easily dependent on the water depth, or a distance from the transducer of the parametric sub-bottom profiling system.

In an example of the present disclosure, the acoustic signal transmitted using a transducer of a parametric sub-bottom profiling system is an impulsive signal.

As can be contemplated by those skilled in the art, for marine applications, impulsive sources are used, which is applicable to the present disclosure.

In an example of the present disclosure, the plurality of source signatures of the transmitted acoustic signal is obtained via direct measurement from recorded seismic seabed pulse.

It is known to those skilled in the art that source signatures of a seismic signal can be obtained by direct measurement from recorded seismic seabed pulse. This can be easily adopted in the present disclosure to determine the needed source signatures.

In an example of the present disclosure, the plurality of source signatures of the transmitted acoustic signal is obtained through a hydrophone.

An example of measuring the source signature is using a near-field hydrophone, which can be conveniently used in marine seismic acquisition to measure variations of the source signal. The method of the present disclosure therefore does not require specially designed hardware.

In an example of the present disclosure, the range threshold is ten meters.

In a further example of the present disclosure, the range threshold is eight meters.

In still a further example of the present disclosure, the range threshold is five meters.

It is determined by study that obtaining the source signatures for water depth ranges of up to ten meters can help to improve the image resolution of the subsequently obtained image profiles. Keeping the measurement relatively sparse or coarse can help to keep the required computational resources low.

As will be understood by those skilled in the art, the water range depths can be made smaller, such as up to eight or five meters, such that more measurements of the source signatures are performed. This is helpful in obtaining image of improved quality from the processed seismic data.

In an example of the present disclosure, the distance threshold is two meters.

It can be contemplated by those skilled in the art that increasing the number of measurements of the source signatures can help to further improve the image resolution. This is achieved at an increased cost of computational resources.

In an example of the present disclosure, the deconvolution is performed using inverse filtering.

The designature or deconvolution of each source signature at a water depth range can be performed using a known deconvolution processing, such as for example inverse filtering. A known software module for performing the deconvolution can be readily used, which will save development cost.

In another example of the present disclosure, the deconvolution is performed using the Least-Squares Inverse Filtering.

Instead of directly inverting the impulse response, the method estimates a filter that minimizes an error between the observed signal and the convolution of the estimated source signal with the filter. This approach takes into account the presence of noise and seeks to find a more robust solution. By minimizing the least-squares error, the process allows further improvement to the data or image resolution while considering noise and system constraints.

In an example of the present disclosure, the generated model is an assembly of the unit-impulse responses at the plurality of water depth ranges.

As can be contemplated by those skilled in the art, the unit-impulse responses obtained by the deconvolution performed at the various water depth ranges can be used advantageously for processing the recorded raw seismic data with a finer granularity, which helps to reveal more geographical information that is not readily available when such processing is not used.

In an example of the present disclosure, the generated model comprises specific wavelets customized to each water depth range.

The generated model is in essence specific wavelets which are customized to each water depth range. This remedy variation of the source signature which is dependent on the water depth, thereby allowing negative effect caused by the varying waveform of the source to be addressed in a more precise manner.

In an example of the present disclosure, the processor is communicatively connected to a remote server.

As can be contemplated by those skilled in the art, the recorded seismic data is normally processed at a remote device or on the cloud than on the site. This enables stronger computational power of server devices to be employed, without imposing unduly burden on other processing devices employed in acquiring the seismic data.

In a second aspect of the present disclosure, there is presented a device for processing recorded seismic data, the recorded seismic data obtained in response to an acoustic signal transmitted using a transducer of a parametric sub-bottom profiling system, a wave shape of the transmitted acoustic signal varying as a function of water depth, the device comprising a processor configured to perform the method according to the first aspect of the present disclosure.

In a third aspect of the present disclosure, there is presented a method of generating an image of a sub-bottom surface from recorded seismic data, the recorded seismic data obtained in response to an acoustic signal transmitted using a transducer of a parametric sub-bottom profiling system, a wave shape of the transmitted acoustic signal varying as a function of water depth, wherein the recorded seismic data is processed according to the first aspect of the present disclosure.

In a fourth aspect of the present disclosure, a computer product is provided, comprising a computer readable storage medium storing instructions which, when executed on at least one processor, cause the at least one processor to carry out the method according to the first aspect of the present disclosure.

The above mentioned and other features and advantages of the disclosure will be best understood from the following description referring to the attached drawings. In the drawings, like reference numerals donate identical parts or parts performing an identical or comparable function or operation.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are therefore not to be considered to be limiting of its scope, the principles herein are described and explained with additional specificity and detail through the use of the accompanying drawings in which:

FIG. 1 schematically illustrates an exemplary embodiment of a marine survey system;

FIG. 2 schematically illustrates in a flow chart type diagram, an embodiment of a method of processing seismic data recorded by a parametric sub-bottom profiling system according to the present disclosure.

FIG. 3 schematically illustrates an example of measuring source signatures at a plurality of water depth ranges in accordance with an embodiment of the present disclosure.

FIG. 4 schematically illustrates a seismic reflection profile in part based on seismic data processed by known seismic processing techniques and in part based on seismic data processed using the method of the present disclosure.

FIGS. 5 and 6 show comparison of seismic reflection profiles based on seismic data processed by known seismic processing techniques and by the method of the present disclosure.

### DESCRIPTION OF ILLUSTRATIVE EMBODIMENTS

Embodiments contemplated by the present disclosure will now be described in more detail with reference to the accompanying drawings. The disclosed subject matter should not be construed as limited to only the embodiments set forth herein. Rather, the illustrated embodiments are provided by way of example to covey the scope of the subject matter to those skilled in the art.

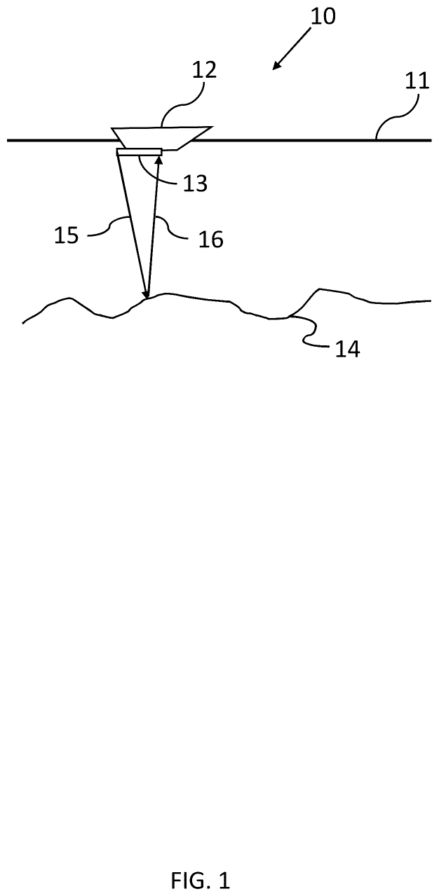

FIG. 1 schematically illustrates an exemplary embodiment of a marine survey system 10. In FIG. 1, a vessel 12 on the sea 11 tows or carries a transmitting device such as a transducer 13 for transmitting a signal 15, such as an acoustic signal, towards a subsurface 14. After being reflected by the subsurface 14, a reflected signal 16 is picked up or recorded by a receiving device such as a receiving part of the same transducer device 13.

In FIG. 1 the transmitting device and the receiving device are illustrated as being integrated into a single transducer device 13. It will be understood by those skilled in the art the they may also be deployed as two separate devices.

In a parametric sub-bottom profiling system, the transducer or specifically its transmitting part 13 transmits, at high sound pressures, a first signal at a first high frequency and a second signal of at a second high frequency which is slightly different form the first high frequency. The first and second frequencies are referred to as primary frequencies. Because of non-linearities in the sound propagation at high pressures both signals interact and new frequencies are arising.

A third frequency equal to a difference between the first and second frequencies, which is also known as a secondary frequency, is a lower frequency than the first and second frequencies and can penetrate the sea bottom.

As a parametric profiler example, when two higher frequencies at 35 and 37 kHz are transmitted by the transmitting device, these two frequencies will interact with the water column to produce a 2 kHz signal with approximately 2 kHz bandwidth.

A wave shape of the lower frequency signal changes with varying water depths as it passes through the water column. In other words, the wave shape of the low frequency source signal is dependent on a distance from the transducer transmitting the source signal. This change in the lower frequency wave shape with varying water depths creates a mixed phase wavelet.

Most traditional signal processing techniques used for processing seismic data rely on the seismic data being in near-zero (minimum) phase. This not only ensures correct application of seismic data processing techniques, but also, increases the fidelity of the processed data.

Because the wave shape changes, the parametric sub bottom profiling systems produce mixed phase wavelet, which cannot be properly addressed by the currently available seismic data processing technique.

To eliminate or reduce or mitigate the impact of the varying wave shape of the lower frequency signal, which is the source signal of the parametric sub-bottom profiling system, the method of the present disclosure makes use of a model which takes into account different source signatures at different water depths.

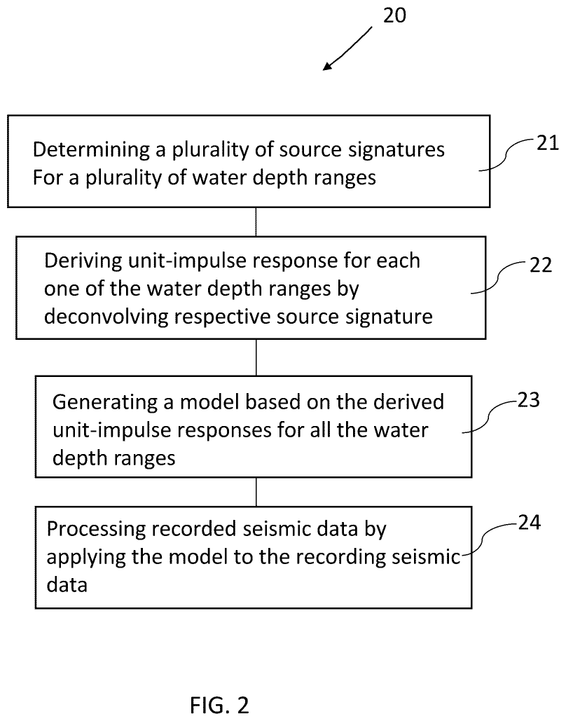

FIG. 2 schematically illustrates, in a flow chart type diagram, an embodiment of a method 20 of processing seismic data recorded by the above described parametric sub-bottom profiling system according to the present disclosure.

Referring to FIG. 2, at step 21, a plurality of source signatures of the transmitted acoustic signal is determined, for example by measuring or estimation, respectively for a plurality of water depth ranges.

Theoretically, the measurement or estimation is performed at multiple water depths with a specific or defined distance or depth interval. In practice, however, it is nearly impossible to measure the change in source signature wavelet shape at fixed intervals. Therefore, a more manageable depth interval, i.e., water depth range is used.

Based on this consideration, an interested water depth range, for example spanning a depth of 50 meters, is divided into a number of smaller ranges, such as for example 10 ranges. In this sense, each range covers a water depth of five meters. A measurement of the source signature is then performed at a location within each range. Each water depth range or seabed depth range may also be conveniently referred to as a “micro”.

As can be contemplated by those skilled in the art, it is not necessary that every water range depth spans or covers a precise water depth. A micro may cover 10 meters while an adjacent micro may cover 9 meters or 9.5 meters. The water depth ranges may also be purposely made different, which will allow the variation of the source signature to be captured or evaluated in a more flexible way.

It may also be understood by those skilled in the art that it is not necessary that adjacent measurements are always performed according to a precise interval, as long as a measurement is performed within each water depth range such that variations of the source signature along the interested water depth is captured to a sufficient extent.

For convenience purposes, it is described that each water depth range within which a measurement of the source signature is performed is smaller than a range threshold.

The range threshold can be set to for example ten meters, which is sufficient to help to improve image resolution of the subsequently obtained image profiles. The range threshold can be for example up to eight or five meters, which allows better image resolution to be obtained at a bit of increased computational cost. A range threshold of two meters may also be used, which would allow for even better image or date resolution.

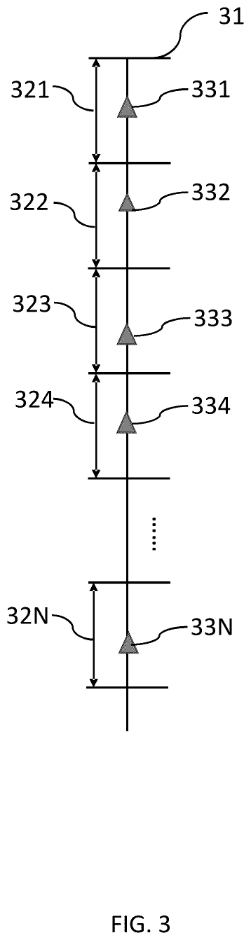

FIG. 3 schematically illustrates an example of measuring source signatures at a plurality of water depth ranges in accordance with an embodiment of the present disclosure.

It will be understood by those skilled in the art that the water depth is the reference used which directly translates to distance of the transmitted wave from the transducer within the water column before it hits the seabed.

In FIG. 3, starting from the position 31 of the transducer, measurements of the source signature are performed at a plurality of locations 331, 332, . . . , 33N respectively located within a number of water depth ranges 321, 322, . . . , 32N. Although the water depth ranges 321, 322, . . . , 32N are illustrated as having or covering a same depth distance, in practice the water depth ranges may have varying depth distances.

Moreover, it is not necessary that each one of the locations 331, 332, . . . , 33N is one at a precise point within the respective water depth range. Therefore, the distance between each pair of neighbouring measurement may also vary. The purpose is that variation of the source signature along the water depth is taken into consideration by having the source signatures at multiple water depth ranges measured.

The estimation or measurement of the source signatures can be done by direct measurements from seabed picks or through a hydrophone such as a far-field hydrophones recorded.

At step 22, a unit-impulse response for each one of the water depth ranges is derived by deconvolving the source signature of the seismic signal at that water depth range.

As known by those skilled in the art, a measured output signal is computed as a convolution of an input wavelet with an impulse response of the subsurface. By deconvolving the output signal by the input wavelet, the unit-impulse response is obtained.

The deconvolution is performed for each source signature measured at a respective water depth range, this allows a plurality of unit-impulse responses to be obtained at multiple water depths where the source signatures are measured.

As an example, the impulse response can be derived by applying a filter operator f (t) according to Equation (1):

$$f ( t ) = δ ( t ) * \frac{1}{w ( t )} \qquad ( 1 )$$

where δ(t) is the Kronecker delta function, w(t) is the input seismic signal.

An alternative way of deriving the impulse response is by way of the Least-Squares Inverse Filtering.

It will be understood by those skilled in the art that the deconvolution can be performed using a known method, as long as it allows the impulse response to be derived in a sufficiently accurate way. Details about the deconvolution processing can be found at “Seismic Data Analysis: Processing, Inversion, and Interpretation of Seismic Chapter 2” by Öz Yilmaz, which is incorporated herein by reference.

At step 23, after deriving the unit-impulse responses for all water depth ranges, a model representing relationship between the source signature of the transmitted acoustic signal at each water depth range and that water depth is generated, based on the derived unit-impulse responses for all the water depth ranges.

The generated model is an assembly of the unit-impulse responses for the different water depths. It relates to a specific set of transmission frequencies, water depth and seabed record length. The model consists of a collection of specific wavelets customized to each “micro” water depth or seabed depth range.

As an example, when source signatures are measured with a depth interval of maximally two meters, a water depth ranging from 5 meter to 50 meter would contain at least 23 micro set of wavelets to make up one dynamic model.

After the model is generated, at step 24, the recorded seismic data is processed by applying the model to the recording seismic data.

The processing allows more accurate representations of source signature at various water depths to be taken into consideration, thereby allowing the impact of the source signatures at different water depths to be reduced to a greater extent, thereby rendering processed data that represents the seabed in a better way. The processing thereby helps to improve the resolution of the subsequently obtained image profiles.

The method of the present disclosure quantifies the effect of the variation of the source signature as a function of the water depths by measuring the source signatures for a plurality of water depth ranges and deriving the impulse responses from the different source signatures at the respective water depth ranges. It thereby allows the recorded seismic data to be processed accordingly based on the derived impulse responses at various water depth, which enables more seismic reflection profiles of better resolution to be obtained.

It will be understood by those skilled in the art that other processing techniques such as band pass filtering, spherical divergence correction and de-noise may also be used on the recorded seismic data, which will not be elaborated here.

The method described above is used to process seismic data recorded using a parametric sub-bottom profiling system. It is noted that the method is not limited to any specific water depth. It can be used to improve the image resolution for applications from shallow water to the deep-sea.

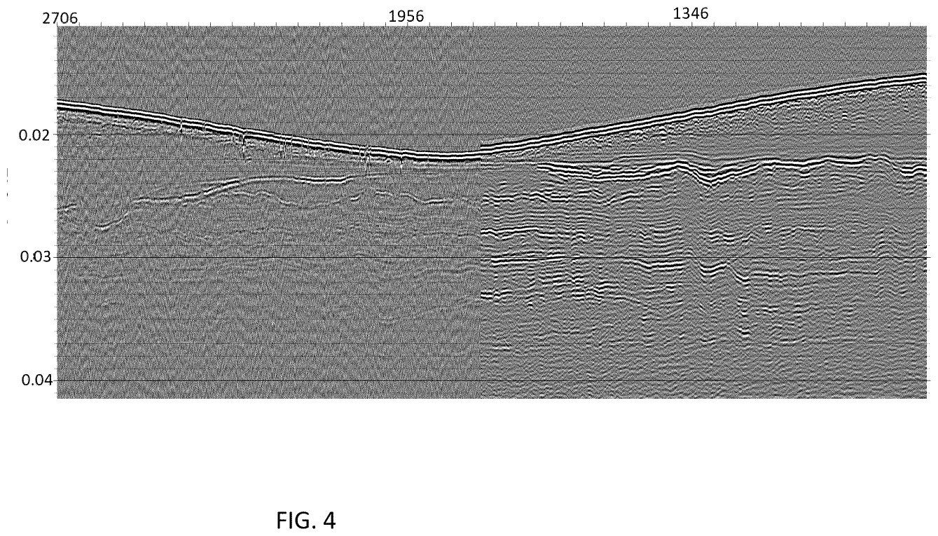

FIG. 4 schematically illustrates a seismic reflection profile in part based on seismic data processed by known seismic processing techniques and in part based on seismic data processed using the method of the present disclosure.

In FIG. 4, the horizontal axis is trace numbers, the vertical axis is two-way travel time in second. Trace numbers 1810 to 2706 on the left half are by known seismic processing techniques, while trace numbers 850 to 1810 on the right half are processing by way of the method of the present disclosure. It is seen clearly from FIG. 4 that the resolution of the data processed according to the present disclosure is significantly improved in comparison to that processed using known techniques, allowing more details to become available.

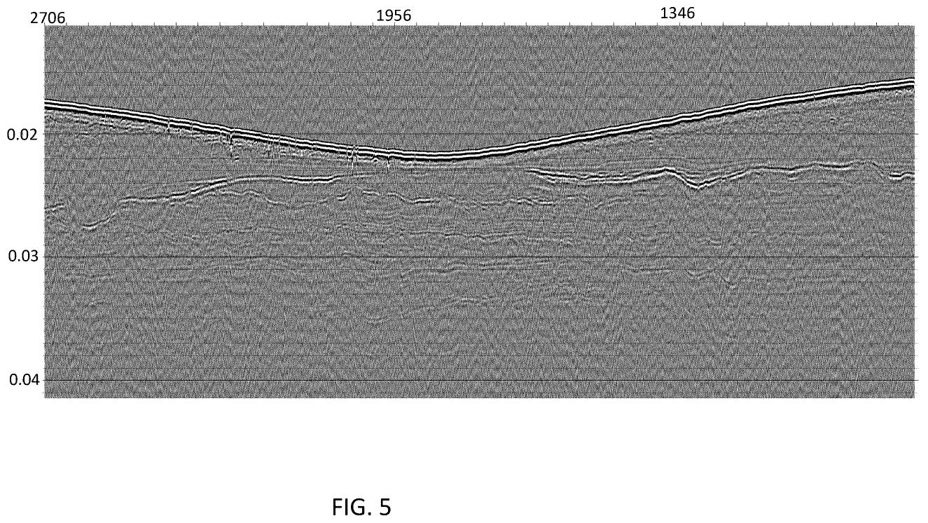

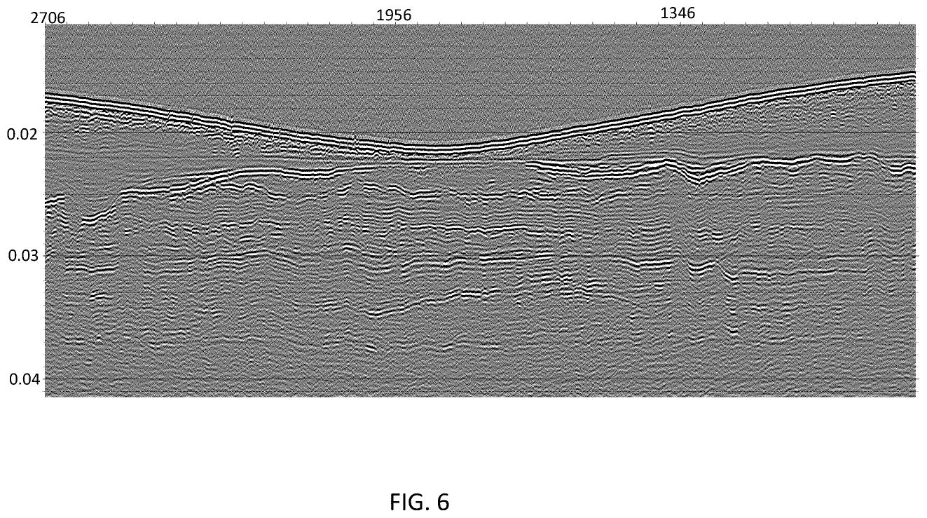

FIGS. 5 and 6 show comparison of seismic reflection profiles based on seismic data processed by some well-known seismic processing techniques, known to those who are skilled in the art, such as band-pass filtering, spherical divergence correction, de-noise and the method of the present disclosure. FIG. 5 is based on the known method, and FIG. 6 is based on the method of the present disclosure.

It can be seen from to FIGS. 5 and 6 that comparing to known method, the method of the present disclosure enables better image resolution to be achieved.

The invention has been described by reference to certain embodiments discussed above. It will be recognized that these embodiments are susceptible to various modifications and alternative forms well known to those of skill in the art.

Further modifications in addition to those described above may be made to the structures and techniques described herein without departing from the spirit and scope of the invention. Accordingly, although specific embodiments have been described, these are examples only and are not limiting upon the scope of the invention.

1. A method of processing recorded seismic data, the recorded seismic data being obtained in response to an acoustic signal transmitted using a transducer of a parametric sub-bottom profiling system, a wave shape of the transmitted acoustic signal varying as a function of water depth, the method comprising:
determining a plurality of source signatures of the transmitted acoustic signal respectively for a plurality of water depth ranges, where each water depth range is smaller than a range threshold;
deriving a unit-impulse response for each one of the water depth ranges by deconvolving the plurality of source signatures of the transmitted acoustic signal at the respective water depth range;
generating a model representing a relationship between the plurality of source signatures of the transmitted acoustic signal at each water depth range and the respective water depth range based on the derived unit-impulse response for the plurality of water depth ranges; and
processing the recorded seismic data by applying the model to the recording seismic data.

2. The method according to claim 1, wherein the transmitted acoustic signal comprises a first frequency and a second frequency, the first frequency and the second frequency interact to produce a third frequency equal to a difference between the first frequency and the second frequency, the recorded seismic data is of the third frequency.

3. The method according to claim 1, wherein the acoustic signal transmitted using the transducer of the parametric sub-bottom profiling system is an impulsive signal.

4. The method according to claim 1, wherein the plurality of source signatures of the transmitted acoustic signal is obtained via direct measurement from recorded a seismic seabed pulse.

5. The method according to claim 1, wherein the plurality of source signatures of the transmitted acoustic signal is obtained through a hydrophone.

6. The method according to claim 1, wherein the range threshold is ten meters.

7. The method according to claim 1, wherein the range threshold is five meters.

8. The method according to claim 1, wherein the deconvolution is performed using inverse filtering.

9. The method according to claim 1, wherein the deconvolution is performed using Least-Squares Inverse Filtering.

10. The method according to claim 1, wherein the generated model is an assembly of the derived unit-impulse responses at the plurality of water depth ranges.

11. The method according to claim 1, wherein the generated model comprises specific wavelets customized to each water depth range.

12. (canceled)

13. A device for processing recorded seismic data, the recorded seismic data obtained in response to an acoustic signal transmitted using a transducer of a parametric sub-bottom profiling system, a wave shape of the transmitted acoustic signal varying as a function of water depth, the device comprising:
a processor; and
a memory storing instructions which when executed by the processor causes the device to:
determine a plurality of source signatures of the transmitted acoustic signal respectively for a plurality of water depth ranges, where each water depth range is smaller than a range threshold;
derive a unit-impulse response for each one of the water depth ranges by deconvolving the plurality of source signatures of the transmitted acoustic signal at the respective water depth range;
generate a model representing a relationship between the plurality of source signatures of the transmitted acoustic signal at each water depth range and the respective water depth range based on the derived unit-impulse response for the plurality of water depth ranges; and
process the recorded seismic data by applying the model to the recording seismic data.

14.-15. (canceled)

16. The device according to claim 13, wherein the transmitted acoustic signal comprises a first frequency and a second frequency, the first frequency and the second frequency interact to produce a third frequency equal to a difference between the first frequency and the second frequency, the recorded seismic data is of the third frequency.

17. The device according to claim 13, wherein the acoustic signal transmitted using the transducer of the parametric sub-bottom profiling system is an impulsive signal.

18. The device according to claim 13, wherein the plurality of source signatures of the transmitted acoustic signal is obtained via direct measurement from recorded a seismic seabed pulse.

19. The device according to claim 13, wherein the plurality of source signatures of the transmitted acoustic signal is obtained through a hydrophone.

20. The device according to claim 13, wherein the range threshold is ten meters.

21. The device according to claim 13, wherein the range threshold is five meters.

22. The device according to claim 13, wherein the deconvolution is performed using inverse filtering.

23. The device according to claim 13, wherein the deconvolution is performed using Least-Squares Inverse Filtering.
